(19) United States
(12) Patent Application Publication
(10) Pub. No.: US 2007/0158437 A1
(43) Pub. Date: Jul. 12, 2007

(54) Portable electronic apparatus comprising in the same microchip a digital processor with cryptography means a large capacity flash memory and a digital signal processor

(76) Inventors: Michel Koenig, Mouans-Sartoux (FR); Frantz Koenig, Nice (FR)

Correspondence Address: Michel Koenig, 946 Chemin des Adrets, Movans-Sartoux, 06370, FR

(21) Appl. No.: 10/592,474

(22) PCT Filed: Mar. 7, 2005
(86) PCT No.: PCT/IB05/01117

§ 371 Date: Sep. 11, 2006

(30) Foreign Application Priority Data
Mar. 10, 2004 (FR) 04/02470

(51) Int. Cl. G06K 19/06

(52) U.S. Cl. 235/492

(57) ABSTRACT

This invention relates in general to a portable electronic apparatus comprising in the same microchip a digital processor with cryptography means a large capacity flash memory and a digital signal processor (FIG. 1) which is entirely embedded into a smart card. This said portable electronic apparatus comprises a digital processor (1) linked directly (17) to a large capacity flash memory (2), this said memory (2) linked directly to a digital signal processor (DSP) (3). This said portable electronic apparatus comprises a direct link (19) between the said digital processor (1) and the said digital signal processor (3). This said portable electronic apparatus comprises a signal switch (4) driven by a signal (11) which, according to its value, establishes a contact between the numerical signals (13, 14) with the contacts (10, 12), or a contact between the analog signals (15, 16) with the contacts (10, 12). This invention concerns particularly the deciphering and storage of encrypted music and video pieces, and the rendering, directly as analog signal of the said music and video pieces, directly amplifiable by common music or video players.

### 1. FIELD OF INVENTION

This invention relates in general to a portable electronic apparatus, entirely embedded into a smart card, comprising a digital processor, means for data input and output, means for cryptography, means for permanent storage of digital information, means for converting digital data into an analog signal; this invention relates in particular to the layout of these elements for receiving encrypted data which represent music or video pieces, decrypting these data, and rendering the content of the music or video pieces as an analog signal which could be amplified and used on ordinary music or video player devices.

### 2. DESCRIPTION OF PRIOR ART

Today, digital recorders allow anybody to make copies of music and video pieces without loss of quality, encroaching upon entitled beneficiaries' rights. This is worse when these pieces are exchanged through public communication networks like Internet.

The producers of music pieces had proposed techniques to protect CDs. These protections are based on some changes of the inner directory of the CD, and cannot allow a PC equipped with a CD player or some HIFI system to play these CDs. Due to these drawbacks, many consumers, who cannot listen to the music or view the video piece they have bought, ask the producer for reimbursement.

Other problems come from the broadcasting of paying music and video pieces over Internet. Encrypting a music or video piece before broadcasting and decrypting it on an ad hoc device for listening to music or viewing videos, offers an entry point to the third party who wants to break down the encryption, due to the fact that the same encryption scheme is used for all the broadcasted music or video pieces.

The customization of the encryption scheme to guarantee that the encrypted music or video piece cannot be decrypted by anyone but its customer, is bound to fail, due to the fact that the devices provided today to listen to or to view these pieces are not customizable.

In the state of the art, it is not possible for the digital processor of the smart cards to do, at the same time, the deciphering of music or video piece and its conversion to analog signal.

In the current devices for listening to music or viewing a video, it is very simple to have access to the numerical data of the music or video piece before that these data are converted into analog signals, thus, it is easy to make a copy of the music or video piece without loss of quality, which encroaches upon entitled beneficiaries' rights.

### 3. OBJECTS AND ADVANTAGES

It is therefore an object of the invention to provide this portable electronic apparatus comprising in the same microchip a digital processor with cryptography means, a large capacity flash memory and a digital signal processor, to remedy to these drawbacks in authorizing only the users who received a license, to decrypt and to listen to the music piece, or to decrypt and to view the video piece, without the possibility to make a numerical copy of the music or video piece, without loss of quality.

Another object of this invention is to provide a two steps process:
In the first step, the digital processor (1) of the smart card decrypts the digital version of the music or video piece, and stores it into an internal memory (2) of the smart card, with no direct access from the outside.
In the second step, the digital signal processor (DSP) (3) converts the deciphered numerical version of the music or video piece into an analog signal.

Another object of this invention is to provide two modes of running: in the first mode, it is possible to store music or video pieces into the internal memory of the smart card after deciphering; in the second mode, it is possible to play the music or video pieces stored into the internal memory of the smart card, using the digital signal processor. In the second mode, the digital processor of the smart card pilots the digital signal processor in order to obtain the usual features of a CD player, or a DVD player. Without setting limits to these features, one could have the following features: skipping to the next music piece or movie chapter, returning to the beginning, accessing a giving music piece or movie chapter.

### 4. BRIEF DESCRIPTION OF THE DRAWINGS

For a further understanding of the objects and advantages of the present invention, references should be made to the following drawings in conjunction with the accompanying descriptions, wherein:

FIG. 1 is an illustrative block diagram of the portable electronic apparatus in this invention;

FIG. 2 is an illustrative diagram of the pin out of the smart card in which is embedded the portable electronic apparatus in this invention.

### 5. DETAILED DESCRIPTION OF THE INVENTION

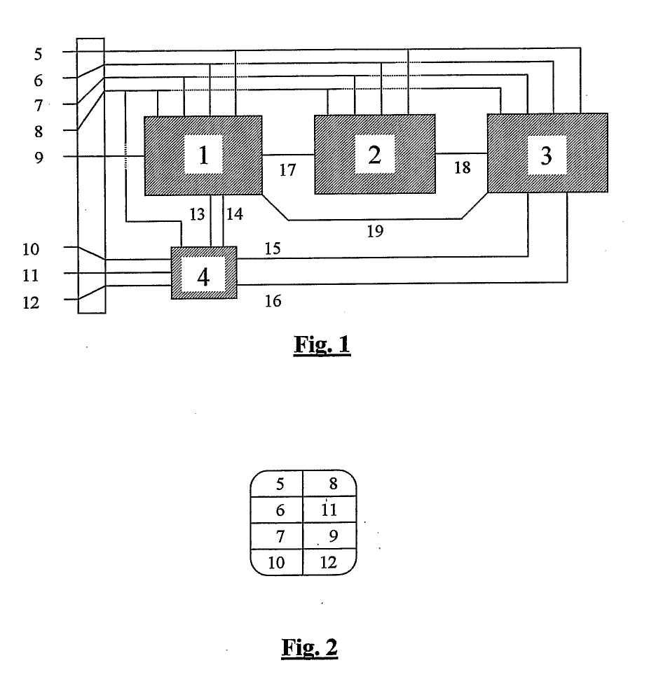

The portable electronic apparatus, in this invention, according to the FIG. 1, comprises:
A digital processor, well-understood in the art, comprising a central processing unit (CPU), memories RAM, ROM, EEPROM, and means for cryptography (1),
A large capacity Flash memory (2),
A digital signal processor (DSP) (3),
A switch (4) driven by an external signal (11).

The portable electronic apparatus, in this invention, is entirely embedded into an ISO7816 smart card. The standard ISO7816 states that the electronic apparatus embedded in the smart card communicates with the smart card readers by the means of contacts.

The layout of these contacts is shown in the FIG. 2:
The contact (5) supplies the electrical power
The contact (8) supplies the ground
The contact (6) provides the Reset signal
The contact (7) provides the clock
The contact (9) provides the input output signals

The contacts 10, 11 and 12 are optional in the standard ISO7816.

The contacts 10, 11 and 12 have a particular role in this invention:
The contact (11) provides a signal to allow the apparatus in this invention, to switch from the mode deciphering/storing, to the mode playing of the stored piece,
The contacts 10 and 12 provide the high rate input output signals to the digital processor, in the mode deciphering/storing, and provide the output analog signal, in the mode playing of the stored piece.

In the mode deciphering/storing, the digital processor (1) receives commands, and returns information, by the means of the contact 9. The digital processor receives data to be decrypted by the means of the contacts 10 and 12, which are connected to the signals 13 and 14 through the switch 4 which is driven by the signal applied to the contact 11.

The digital processor (1) maintains a deciphering key in its internal EEPROM memory. This key has been installed, using a well-understood technique, during a phase of customization.

During the mode deciphering/storing, the digital processor (1) receives the encrypted digital version of the music or music pieces by the means of the signals 13 and 14. The digital processor (1) decrypts the music or video pieces, and stores them into the large capacity flash memory (2) using the data and address bus (17).

During the mode playing of the stored piece, the digital processor (1), from the commands sent to it through the signal (9), drives the digital signal processor DSP (3). During the mode playing of the stored piece, the digital signal processor DSP (3), retrieves the decrypted data corresponding to the music or video piece from the large capacity Flash memory (2), by the means of the data and address bus (18). The digital signal processor DSP (3) provides two analog signals 15 and 16 which are switched to the contacts 10 and 12 according to the signal 11.

The portable electronic apparatus in this invention allows a customer to download, from a communication network like Internet, music or video pieces which have been encrypted to his own usage, to decrypt and store these music and video pieces into the apparatus in this invention, thereafter playing these pieces on a common device adapted to the portable electronic apparatus in this invention.

As an example, but not limited to it, the portable electronic apparatus in this invention could be inserted into a smart card reader, this smart card itself could be connected to a computer through an USB connection, in order to download and decrypt, from Internet, encrypted music or video pieces. Thereafter, the portable electronic apparatus in this invention could be inserted into a music or video player equipped with a smart card reader adapted to the portable electronic apparatus in this invention. The internal amplifier of the device could pick up the analog signals 10 and 11, amplify them and send them to the earphones and/or the video display of the music or video player.

1. A portable electronic apparatus comprising a digital processor (1) with means of cryptography, a large capacity flash memory (2), a digital signal processor (3), a signal switch (4), an external control bus made of signals (5)(6)(7)(8)(9) and an external control bus made of signals (10)(11)(12), where the said digital processor (1) is linked to the said large capacity flash memory (2) using a data and address bus (17), where the said digital signal processor (3) is linked to the said large capacity flash memory (2) using a data and address bus (18), where the said digital processor (1) is linked to the said digital signal processor (3) using a data and address bus (19), where the said digital processor (1) drives the said digital signal processor (3) using the said data and address bus (19).

2. The portable electronic apparatus as recited in claim 1, where the said digital processor (1) is linked to the said signal switch (4) through two signals (13) et (14).

3. The portable electronic apparatus as recited in claim 1, where the said digital signal processor (3) is linked to the said signal switch (4) through two signals (15) et (16).

4. The portable electronic apparatus as recited in claims 1, 2 and 3, where the said signal switch (4), according to the said signal (11), establishes a connection between the said signals (10) and (12) either to the said signals (13) and (14), or to the said signals (15) and (16).

5. The portable electronic apparatus as recited in claim 1, 2 and 4, where the data arriving with the said signals (13,14) are decrypted by the said digital processor (1) and stored into the said large capacity flash memory (2).

6. The portable electronic apparatus as recited in claim 1, 3 and 4, where the said digital signal processor (3) receives data from the said large capacity flash memory (2) through the said data and address bus (18) and produces analog signals (15,16).

7. The portable electronic apparatus as recited in claim 1, where the said portable electronic apparatus is entirely embedded into a smart card.
